(19) United States
(12) Patent Application Publication
(10) Pub. No.: US 2009/0073695 A1
(43) Pub. Date: Mar. 19, 2009

(54) Illumination Apparatus for Microscopes

(76) Inventor: Atsuyoshi Shimamoto, Tokyo (JP)

Correspondence Address: ARNOLD INTERNATIONAL, P.O. BOX 129, Great Falls, VA, 22066-0129, US

(21) Appl. No.: 12/205,872

(22) Filed: Sep. 6, 2008

(30) Foreign Application Priority Data
Sep. 14, 2007 (JP) 2007-240120

(51) Int. Cl. F21V 5/04

(52) U.S. Cl. 362/268

(57) ABSTRACT

The illumination apparatus of microscopes comprises a collector lens for converting diversion light emanated from a light source into parallel luminous flux; a fly eye lens arranged near a backside focal position of the collector lens; and a vertical illuminator which projects two or more light source images formed by the fly eye lens on the incidence pupil of an objective lens. It is characterised in that it has a regulation means by which a diameter of luminous flux between the collector lens and the fly eye lens is changed according to selection of the objective lens.

This application claims benefits of Japanese Patent Application No. 2007-240120 filed in Japan on Sep. 14, 2007, the contents of which are hereby incorporated by reference.

### BACKGROUND OF THE INVENTION

1. Field of the Invention

The present invention relates to an illumination system for microscopes.

2. Description of the Related Art

In conventional illumination apparatus for microscopes, a microscope apparatus with Koehler illumination equipment has been generally used. In the Koehler illumination equipment, a slight nonuniformity corresponding to luminous intensity distribution characteristics of a light source is observed. However, a nonuniformity corresponding to a luminance distribution by a position in the light source is not observed. Therefore, it has been spreading as the most adequate illumination apparatus that an illumination nonuniformity does not generate easily.

However, in recent years, photographing of a digital image has been generally used also in the microscope field by technical improvement by spreading of photoelectric conversion elements such as CCD etc. As a consequence, there is a trend such that even slight illumination nonuniformity which might not be disturbed in observation by naked eyes is noticeable, and thus this becomes to bring a problem.

As a technology for reducing such illumination nonuniformity, an illumination apparatus using a fly eye lens has been known. For example, in Published Unexamined Patent Applications Toku Kai 2002-6225, and Toku Kai 2005-43517, illumination apparatuses for microscopes in which a fly eye lens is arranged near a backside focal position of the collector lens, a pseudo surface light source formed in the fly eye lens element of the fly eye lens is projected to an aperture stop and a illumination lens in order that an illumination nonuniformity generated owing to an angle is eliminated have been shown.

### SUMMARY OF THE INVENTION

The present invention is characterized in that in an illumination apparatus provided with a collector lens for converting diversion light emanated from a light source into parallel luminous flux; a fly eye lens arranged near a backside focal position of the collector lens; and a vertical illuminator which projects two or more light source images formed by the fly eye lens on the incidence pupil of an objective lens, a regulation means by which a diameter of luminous flux between the collector lens and the fly eye lens is changed according to selection of the objective lens is arranged.

By such constitution as mentioned above, an eclipse by an element of the fly eye lens or a pupil of the objective lens can be prevented.

According to the present invention, it is characterized in that the regulation means has two or more collector lenses having different optical characteristics, wherein the diameter of luminous flux may be changed by inserting into the collector lens, or leaving it from its optical path.

According to the present invention, it is characterized in that as for the regulation means, the collector lens consists of two or more lenses, wherein the diameter of the luminous flux is changed by moving some of the lenses.

According to the present invention, it is characterized in that the regulation means is constituted such that the focal length of the collector lens may be adjusted so as to satisfy the following condition:

a×(f_{fly}/f_{cl})≦p

where the maximum diameter of an the light source is set to a; a focal length of the fly eye lens is set to f_{fly}; a focal length of the collector lens is set to f_{cl}; and an inscribed diameter of the fly eye lens element is set to p.

According to the present invention, it is characterized in that the regulation means is constituted such that the diameter of the luminous flux may be adjusted so as to satisfy the following condition:

D≧2a×f_{fly}×NA_{cl}/p

where the maximum diameter of an the light source is set to a; a focal length of the the fly eye lens is set to f_{fly}; a numerical number of the collector lens is set to NA_{cl}; an inscribed diameter of the fly eye lens element is set to p, and a diameter of the luminous flux is set to D.

According to the present invention, it is characterized in that the regulation means is constituted such that the diameter of the luminous flux may be adjusted so as to satisfy the following condition;

D≦q/γ

where a projection magnification of the vertical illuminator is set to γ; a diameter of a pupil of a the objective lens is set to q; a diameter of the luminous flux is set to D.

According to the present invention, it is characterized in that the regulation means is constituted such that the diameter of the luminous flux may be adjusted so as to satisfy the following condition:

2a×f_{fly}×NA_{cl}/P≦D≦q/γ

when the maximum diameter of an the light source is set to a; a focal length of the the fly eye lens is set to f_{fly}; a numerical number of the collector lens is set to N_{Acl}; an inscribed diameter of the fly eye lens element is set to p; a projection magnification of the vertical illuminator is set to γ; a diameter of a pupil of the objective lens is set to q; and a diameter of the luminous flux is set to D.

According to the present invention, it is characterized in that in an illumination apparatus for microscopes provided with a collector lens for converting diversion light emanated from a light source into parallel luminous flux; a fly eye lens arranged near a backside focal position of the collector lens; and a vertical illuminator which projects two or more light source images formed by the fly eye lens on the incidence pupil of the objective lens, wherein the following condition is satisfied:

2a×f_{fly}×NA_{cl}/P≦D≦q/γ

where a diameter of luminous flux between the collector lens and the fly eye lens is set to D; the maximum diameter of an the light source is set to a; a focal length of the the fly eye lens is set to f_{fly}; a numerical number of the collector lens is set to NA_{cl}; an inscribed diameter of the fly eye lens element is set to p, a projection magnification of the vertical illuminator is set to γ; and a diameter of the pupil of the objective lens selected from two or more objective lenses is set to q.

According to the present invention, a fly eye optical system for projecting illumination light from a light source on a sample surface without loss can be offered. Moreover, illumination for achieving an optimal illumination efficiency according to an objective lens used can be obtained. Namely, brighter illumination can be obtained even when the same light source is used.

These and other features and advantages of the present invention will become apparent from the following detailed description of the preferred embodiments when taken in conjunction with the accompanying drawings.

### BRIEF DESCRIPTION OF THE DRAWINGS

FIGS. 1A, 1B, and 1C are diagrams showing an outside views of a fly eye lens.

FIG. 2 is a schematic diagram for explaining the structure of a fly eye lens illumination system.

FIG. 3 is a diagram showing optical paths of an optical system from a light source to an exit surface of the fly eye lens.

FIG. 4 is a diagram for explaining a condition on an exit surface of the fly eye lens.

FIG. 5 is a diagram showing optical paths of an optical system from the exit surface of the fly eye lens to the object lens.

FIGS. 6A and 6B are graphic charts showing relations between a diameter of luminous flux and an illumination efficiency.

FIG. 7 is a schematic diagram showing a constitution of an embodiment of a microscope equipped with the illumination apparatus according to the present invention.

FIG. 8 is a schematic diagram showing an example of a constitution of an embodiment shown in FIG. 7.

FIG. 9 is a schematic diagram showing a constitution of another embodiment of the microscope equipped with the illumination apparatus according to the present invention.

### DETAILED DESCRIPTION OF THE PREFERRED EMBODIMENTS

Hereafter, embodiments of the present invention will be explained using drawings.

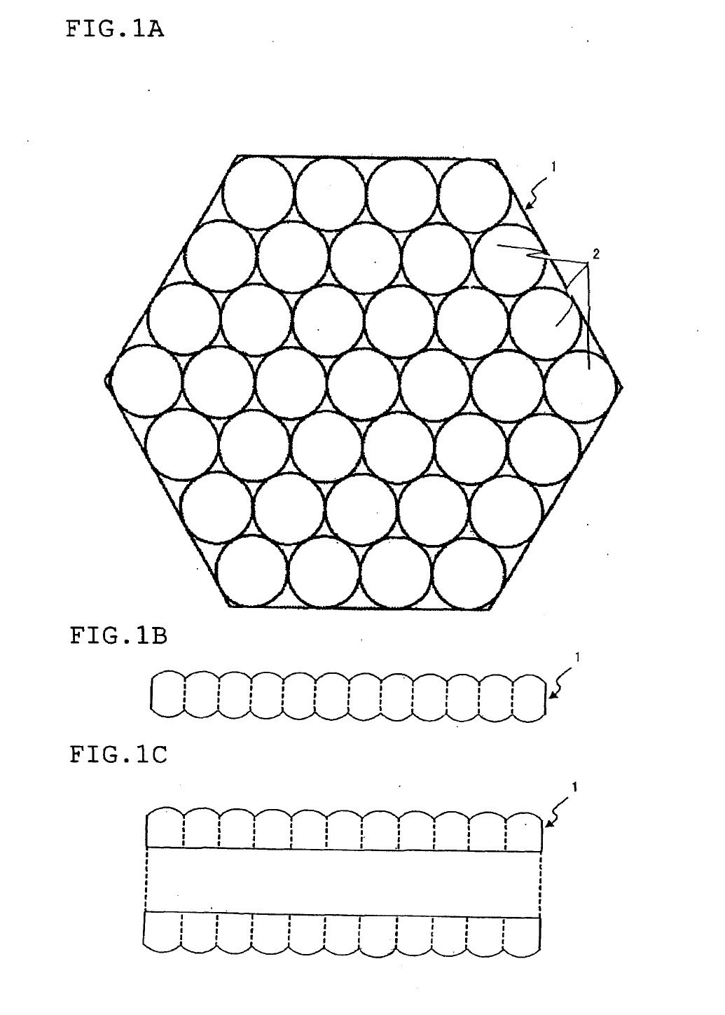

FIGS. 1A, 1B, and 1C show an example of a form of a fly eye lens. As shown in FIG. 1A, the fly eye lens 1 is an optical element in which small elemental lenses 2 are regularly arranged. Accordingly, it is called as fly eye lens or lens array by such form. FIGS. 1B is a diagram showing an outside views of a fly eye lens. As shown in FIG. 1B, curvature of the elemental lenses 2 of the fly eye lens 1 are arranged so that each optical axis of them may be in agreement with the front surface and the back surface. FIGS. 1C is a diagram showing a sectional views of a modified example of the fly eye lens. The fly eye lens 1 shown in FIG. 1C is constituted such that two fly eye lenses having convex and flat surfaces are combined. The fly eye lens constituted as mentioned above can be easily manufactured compared with a lens with a long focal length.

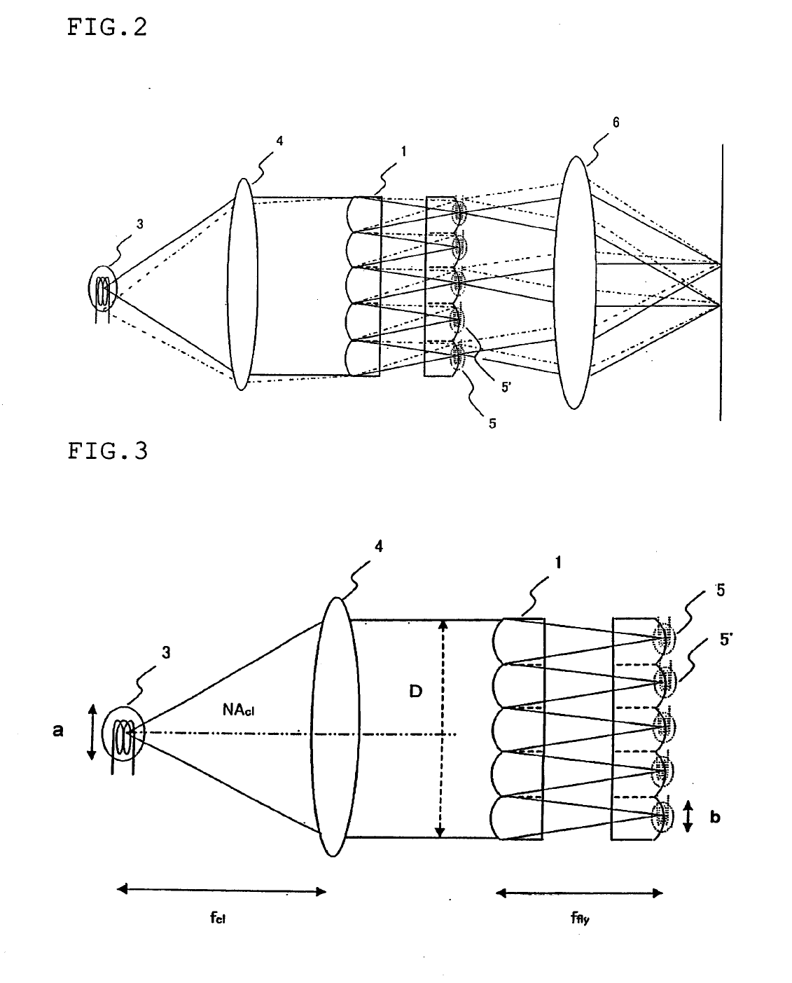

FIG. 2 is a schematic diagram for explaining a structure of the fly eye lens for correcting illumination nonuniformity. In FIG. 2, in order to make the drawing legible, a line showing light ray is omitted properly, but partially shown. Since a common objective lens 6 has a pupil position in the objective lens, it has an optical system for relaying the pupil (refer to FIG. 5). In an example of the constitution of FIG. 2, the illumination light emitted from the light source 3 is changed into parallel luminous flux by a collector lens 4, and is irradiated to the fly eye lens 1. Here, if the focal length of the fly eye lens 1 is designed to be around a distance between the front surface and the back surface of the fly eye lens 1, images of the light source 3 are formed by the number of elemental lenses near the exit surface of the fly eye lens 1. That is, the exit surface of the fly eye lens 1 can be regarded as a new light source which is constituted with many small light sources (images 5 and 5′, - - - of the light source 3,). Here, luminance of each of images 5, 5′, - - - of the light source 3 is determined corresponding to an exit angle of the illumination light emanated from the light source 3. That is to say, the images 5, 5′, - - - of the light source 3 become a light source that divides light distribution of the light source 3. Then, by setting the exit surface of the fly eye lens 1 as a pupil surface (or conjugate position of a pupil surface) of the objective lens 6, illumination which negates a luminous intensity distribution characteristics of the light source 3 is realized. As mentioned above, although the illumination using the fly eye lens can correct nonuniformity by the luminous intensity distribution characteristics of the light source, in some cases, it is necessary to take into consideration of lack of the illumination light. Then, next, optimization of an illumination optical system using a fly eye lens will be explained.

In FIG. 3, an optical system extracted from the light source 3 to the exit surface of the fly eye lens 1 is shown, and parameters required for optimization of the optical system are attached. In FIG. 3, the maximum diameter of an the light source is set to a; a focal length of the collector lens 4 is set to fcl; a numerical aperture is set to NA cl, and a focal length of the fly eye lens 1 is set to ffly. Here, as for the light source 3, in order to argue about the performance of an illumination optical system of the fly eye lens, it is assumed that it has ideally a circular form with diameter a, and a constant luminance distribution. For example, it is considered, as such a light source, a surface light source like LED, and secondary light sources such as an end surface of an integrator rod etc. In figures attached, for convenience sake of drawing, the light source is shown as a light source with a filament. In working of the present invention it is not limited to the light source with a filament. In this case, when the maximum diameter of an image of the light source 3 in the exit surface of the fly eye lens 1 is set to b, b=a×f_{fly}/f_{cl} is given, And, when a diameter of the flux of light emanated from the collector lens 4 is set to D, D=2f_{cl}×NA_{cl} is given. Here, one condition is given. That is to say, it is not desired that a size of the image 5 of the light source exceeds a diameter of an inscribed circle of the elemental lens 2 of the fly eye lens 1, since eclipse of the image of the light source 3 occurs by a bore (inside diameter) of the elemental lens. Namely, the condition for the optimization used by the present invention is shown as follows;

b=a×(f_{fly}/f_{cl})≦P (1)

where the bore of the elemental lens 2 is set to P.

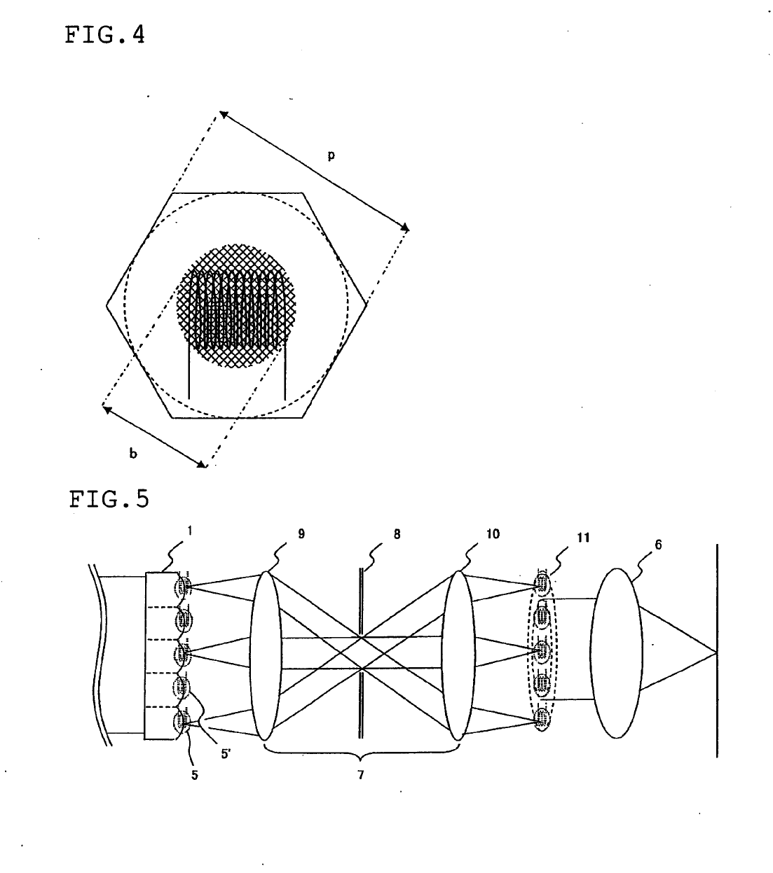

FIG. 4 illustrates this condition. This condition can be expressed also as follows:

D≧2a×f_{fly}×NA_{cl}/P (2)

In Publication of the Japanese unexamined patent application, Toku Kai No. 2005-43517, a constitution satisfying the following condition has been disclosed.

d/2<12(W²+Dl²)^{1/2}×(fe/fc)<d

where a size of width of a light source is set to W; a size of height of the light source is set to Dl; a focal length of the collector lens 4 is set to fc; a focal length of one of elements which constitutes the fly eye lens is set to fe; and, an inscribed diameter of one of elements which constitutes the fly eye lens element is set to d.

When this condition is rewritten by the describing method mentioned above of the present invention, it is expressed as follows:

p/4≦a×(f_{fly}/f_{cl})≦p/2

According to the optimization condition (1) in the present invention, it shows that a larger sized light source than that in the Publication of the Japanese unexamined patent application, Toku Kai No. 2005-43517 can be used.

Next, other conditions in optimization of the present invention will be explained. FIG. 5 is a schematic diagram that extracted optical paths from an exit surface of the fly eye lens 1 to the objective lens 6 in the illumination optical system using the fly eye lens. In FIG. 5, a vertical illuminator 7 which has been currently omitted in FIG. 2 is illustrated. A role of the vertical illuminator 7 restricts an illumination field by a field diaphragm 8 while it is used in order to lead illumination light to the objective lens 6. In FIG. 5, an optical system of the vertical illuminator 7 is schematically shown by the first vertical illuminator lens 9 and the second vertical illuminator lens 10. Here, a diameter D of a pseudo surface light source which is formed by the image 5 of the light source 3 projected on the exit surface of the fly eye lens 1 is projected in a size D×(f₂/f₁) at a pupil position of the objective lens, when a focal length of the first incident light illumination, lens 9 is set to f₁, and a focal length of the second incident light illumination lens 10 is set to f₂. It is not desired that a size of the light source image 11 in this pupil position becomes larger than the diameter q of a pupil of the objective lens 6, because the illumination light of the portion is lost. Namely, it desired that the following condition is satisfied:

D×(f₂/f₁)≦q (3)

where f₂/f₁ is a projection magnification of the vertical illuminator.
From the above, the diameter D of the flux of light emanated from the collector lens 4 must not be too small (refer to formula (3)), and too large (refer to formula (2)). Moreover, the optimum condition depends upon the objective lens (a diameter of the pupil of it).

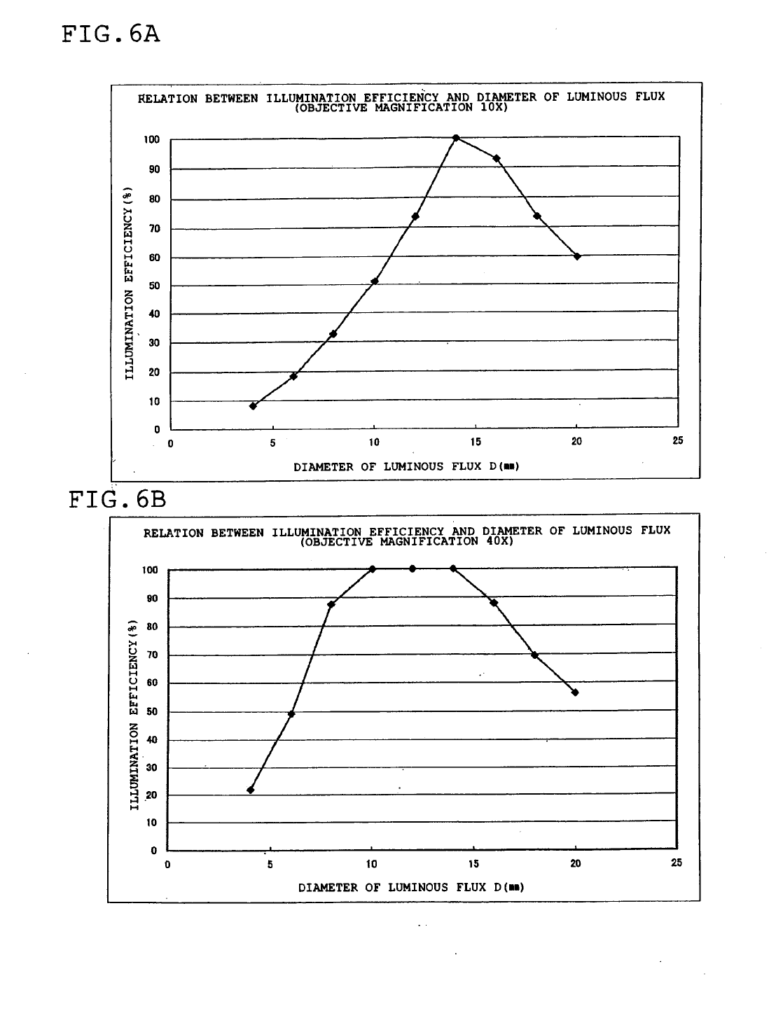

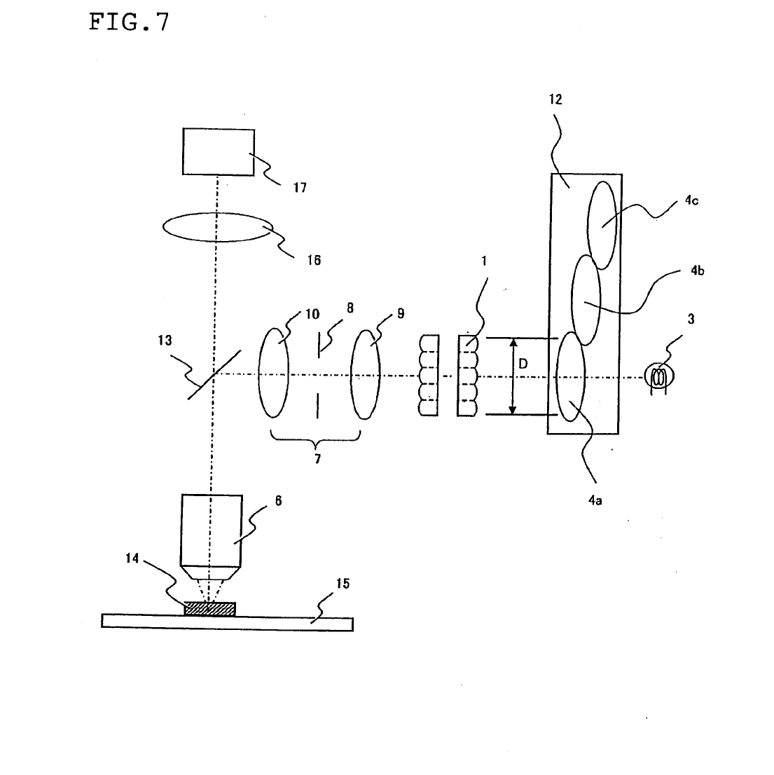

FIGS. 6A and 6B are diagrammatic charts showing illumination efficiency when a diameter of luminous flux D is varied in two objective lenses, (an objective magnification 10×, and an objective magnification 40×). As seen in the diagrammatic chart shown in FIG. 6, the diameter of luminous flux D which makes illumination efficiency maximize changes by objective lenses. Since luminance distribution of an image of the pseudo surface light source formed on an end surface of the fly eye lens is reflected by light distribution characteristics of the light source as it is, it is necessary to calculate the illumination efficiency which loses with the object pupil taking into consideration of the effect mentioned above. However, here, the calculation of illumination efficiency is carried out by considering that the luminous intensity distribution characteristics of the light source is isotropic. But also when there is a luminous intensity distribution characteristics of the light source, by the same reason mentioned above, the diameter of luminous flux D which brings the illumination efficiency maximize changes by objective lenses. Then, for optimization of the optical system in the present invention it is desired that the objective lens to be used is appropriately chosen. Otherwise, a method in which selection of an objective lens is restricted, and the illumination system optimized by those objective lenses is fixed and used can be also considered.

FIG. 7 shows a constitution such that the collector lens 4 is selected by the revolver 12 as an example of the regulation means for making the luminous flux diameter D variable. In this regulation means, the illumination light emanated from the light source 3 is changed into the parallel pencil of the diameter of luminous flux D by the collector lens 4 chosen by rotation of a revolver 12, it enters into a fly eye lens 1. At this time, it is desired that a collector lens is selected so that the conditions (2) and (3) by optimization of the present invention may be satisfied. The illumination light which satisfies this condition and enters into the fly eye lens 1, can be use to illuminate a sample 14 on a stage 15, without generating any eclipse on the exit surface of the fly eye lens 1, and on the pupil surface of the objective lens 6 The sample 14 on a stage 15. In FIG. 7, a numerical symbol 13 stand for light separation means such as a dichroic mirror, a half mirror and the like. At this time, in an incident light bright-field observation a half mirror as the light separation means 13 is generally used. In an incident light fluorescence observation, the dichroic mirror as the light separation means 13 is generally used. When using the dichroic mirror, it is rare to use it independently, and generally, a unit that a excitation filter and a fluorescence filter (called a fluorescence cube) are united is used. An image of observation light which is separated from illumination light by a light separation means 13 is formed on a light receiving surface of an image sensors 17 (CCD) by an image forming lens 16. Of course, a constitution in which observation is carried out by naked eye through an eyepiece can be considered.

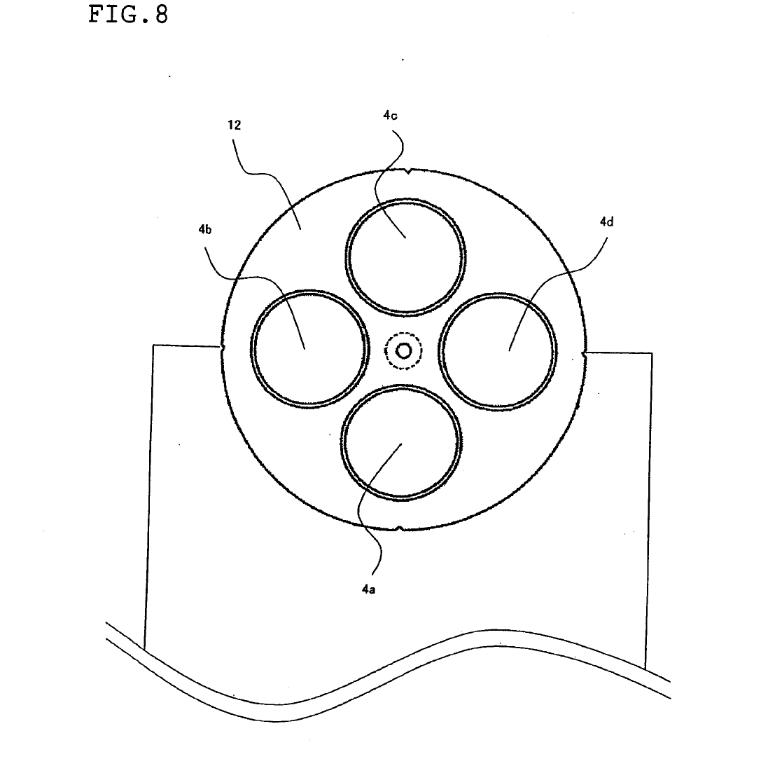

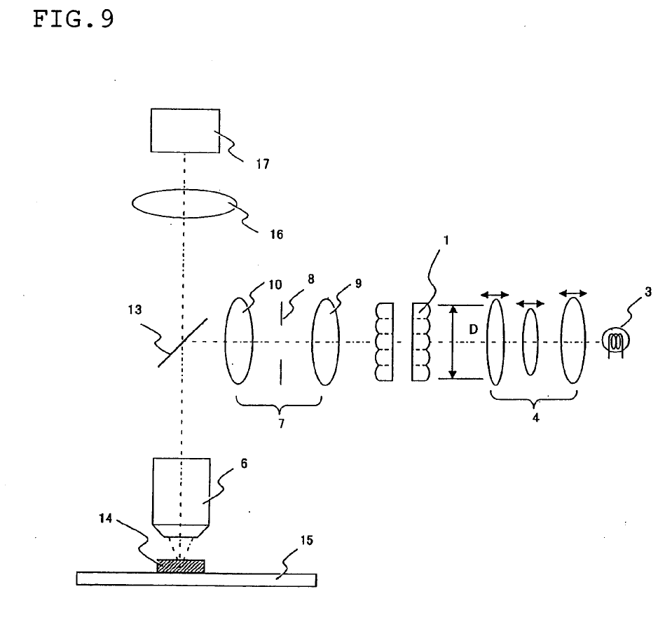

FIG. 8 is a schematic diagram of a cross section of a revolver 12 to the optical axis. In the present example, it is constituted such that in the revolver 12, collector lenses 4a, 4b, 4c, and 4d of four sheets are arranged, and a collector lens can be selected by rotating the revolver 12. FIG. 9 is a schematic diagram showing, as an example of another regulation means for making a diameter of luminous flux D variable, a constitution in which an optical system contains driving lenses called variator in the collector lens 4. In the present regulation means, the collector lens 4 consists of two or more lenses, and a focal length fcl as an optical system of the collector lens 4 can be changed by moving some lenses in it. Thus, it will be easily understood that when the focal length f_{cl} (and a distance from the light source 3) changes, the diameter of luminous flux D changes by the following condition: D=2f_{cl}×NA_{cl}

That is, by moving the optical system of the contact lens 4 and adjusting appropriately the diameter of luminous flux D so that the condition of optimization of the present invention may be satisfied, optimal illumination with little loss can be realized.

As a modified example of the present invention, it can be considered that a constitution in which the optical system of the vertical illuminator 7 is made to be variable. For example, if the optical system of the vertical illuminator 7 is constituted as an optical system with variable magnification, a size of the light source image 11 at the pupil position of the objective lens 6 can be changed. In this constitution, even though an eclipse on the exit surface of the fly eye lens cannot be prevented, an eclipse by the diameter of a pupil of the objective lens 6 can be prevented.

1. An illumination apparatus for microscopes comprising:
a collector lens for converting diversion light emanating from a light source into a parallel luminous flux,
a fly eye lens arranged near a backside focal position of the collector lens, a
a vertical illuminator which projects two or more light source images formed by the fly eye lens onto an incidence pupil of an objective lens, and
a regulation means;
wherein
the regulation means a enables the diameter of the parallel luminous flux between the collector lens and the fly eye lens to be changed.

2. The illumination apparatus for microscopes according to claim 1, wherein
the regulation means is equipped with two or more collector lenses having different optical characteristics, and
the diameter of luminous flux can be changed by selectively inserting one of said two or more collector lenses into, or leaving it outside of, the luminous flux.

3. The illumination apparatus for microscopes according to claim 1, wherein
the regulation means is constituted such that the collector lens consists of two or more lenses, and
the luminous flux diameter is changed by moving some of the collector lenses.

4. The illumination apparatus for microscopes according to claim 1, wherein
the regulation means is constituted such that the focal length of the collector lens may be adjusted so as to satisfy the following condition:
a×(f_{fly}/f_{cl})≦p
where
a is a maximum diameter of the light source,
f_{fly} is the focal length of the fly eye lens,
f_{cl} is the focal length of the collector lens, and
p is an inscribed diameter of the fly eye lens.

5. The illumination apparatus for microscopes according to claim 1, wherein
the regulation means is constituted such that the diameter of the luminous flux may be adjusted so as to satisfy the following condition:
D≧2a×f_{fly}×NA_{cl}/p
where
D is the diameter of the luminous flux,
a is a maximum diameter of the light source,
f_{fly} is the focal length of the fly eye lens,
NA_{cl} is the numerical aperture of the collector lens, and
p is an inscribed diameter of the fly eye lens.

6. The illumination apparatus for microscopes according to claim 1, wherein
the regulation means is constituted such that the diameter of the luminous flux may be adjusted so as to satisfy the following condition:
D≦q/γ
where
D is the diameter of the luminous flux,
q is the diameter of a pupil of the objective lens, and
γ is the projection magnification of the vertical illuminator.

7. The illumination apparatus for microscopes according to claim 1, wherein
the regulation means is constituted such that the diameter of the luminous flux may be adjusted so as to satisfy the following condition:
2a×f_{fly}×NA_{cl}/p≦D≦q/γ
where
a is a maximum diameter of the light source,
f_{fly} is the focal length of the fly eye lens,
NA_{cl} is the numerical aperture of the collector lens,
p is an inscribed diameter of the fly eye lens,
D is the diameter of the luminous flux,
q is the diameter of a pupil of the objective lens, and
γ is the projection magnification of the vertical illuminator.

8. An illumination apparatus for microscopes comprising:
a collector lens for converting diversion light emanated from a light source into a parallel luminous flux;
a fly eye lens arranged near a backside focal position of the collector lens; and
a vertical illuminator which projects two or more light source images formed by the fly eye lens onto an incidence pupil of an objective lens,
wherein
the following condition is satisfied:
2a×f_{fly}×NA_{cl}/p≦D≦q/γ
where
a is a maximum diameter of the light source,
f_{fly} is the focal length of the fly eye lens,
NA_{cl} is the numerical aperture of the collector lens,
p is an inscribed diameter of the fly eye lens,
D is the diameter of the luminous flux,
q is the diameter of a pupil of the objective lens, and
γ is the projection magnification of the vertical illuminator.

9. The illumination apparatus for microscopes according to claim 2, wherein
the regulation means is constituted such that focal length of the collector lens may be adjusted so as to satisfy the following condition:
a×(f_{fly}/f_{cl})≦p
where
a is a maximum diameter of the light source,
f_{fly} is the focal length of the fly eye lens,
f_{cl} is the focal length of the collector lens, and
p is an inscribed diameter of the fly eye lens.

10. The illumination apparatus for microscopes according to claim 2, wherein
the regulation means is constituted such that the diameter of the luminous flux may be adjusted so as to satisfy the following condition:
D≧2a×f_{fly}×NA_{cl}/p
where
D is the diameter of the luminous flux,
a is a maximum diameter of the light source,
f_{fly} is the focal length of the fly eye lens,
NA_{cl} is the numerical aperture of the collector lens, and
p is an inscribed diameter of the fly eye lens.

11. The illumination apparatus for microscopes according to claim 2, wherein
the regulation means is constituted such that the diameter of the luminous flux may be adjusted so as to satisfy the following condition:
D≦q/γ
where
D is the diameter of the luminous flux,
q is the diameter of a pupil of the objective lens, and
γ is the projection magnification of the vertical illuminator.

12. The illumination apparatus for microscopes according to claim 2, wherein
the regulation means is constituted such that the diameter of the luminous flux may be adjusted so as to satisfy the following condition:
2a×f_{fly}×NA_{cl}/p≦D≦q/γ
where
a is a maximum diameter of the light source,
f_{fly} is the focal length of the fly eye lens,
NA_{cl} is the numerical aperture of the collector lens,
p is an inscribed diameter of the fly eye lens,
D is the diameter of the luminous flux,
q is the diameter of a pupil of the objective lens, and
γ is the projection magnification of the vertical illuminator.
